(19) United States
(12) Patent Application Publication
(10) Pub. No.: US 2016/0065865 A1
(43) Pub. Date: Mar. 3, 2016

(54) IMAGING DEVICE AND IMAGING SYSTEM

(71) Applicant: HITACHI MAXELL, LTD., Osaka (JP)

(72) Inventors: Junji SHIOKAWA, Tokyo (JP); Yuuichi NONAKA, Tokyo (JP); Takeru KISANUKI, Tokyo (JP); Akihito NISHIZAWA, Tokyo (JP)

(21) Appl. No.: 14/786,230

(22) PCT Filed: Apr. 4, 2014
(86) PCT No.: PCT/JP2014/059996

§ 371 Date: Oct. 22, 2015

(30) Foreign Application Priority Data
Apr. 24, 2013 (JP) 2013-090882

(51) Int. Cl. H04N 5/33; H04N 5/225; H04N 9/07

(52) U.S. Cl. CPC H04N 5/332; H04N 9/07; H04N 5/2256

(57) ABSTRACT

The imaging device includes an imaging unit that acquires a visible light signal and an invisible light signal by imaging a subject, a first luminance generation unit that generates a visible light luminance signal by using the visible light signal output from the imaging unit, a second luminance generation unit that generates an invisible light luminance signal by using the invisible light signal output from the imaging unit, an image correction processing unit that performs a correction process by using the visible light luminance signal generated by the first luminance generation unit and the invisible light luminance signal generated by the second luminance generation unit, and a control unit that controls at least the image correction processing unit; and the image correction processing unit performs the correction process by adding a correction signal, which is generated using the invisible light luminance signal, to the visible light signal.

### TECHNICAL FIELD

The present invention relates to an imaging device and an imaging system.

### BACKGROUND ART

As the background art of the present technical field, there is Patent Document 1 (Japanese Patent Application Laid-Open No. 2003-189297). Patent Document 1 discloses that “(Problem to be solved) To provide an image processor and an imaging device capable of improving the visibility of a target object (Solving means). The image processor obtains an address of a pixel having higher luminance in pixels constituting a visible image, and decreases luminance of pixels of an infrared image of an address corresponding to the obtained address. In addition, an infrared light source 4 is intermittently turned on in synchronization with a time when the infrared image is obtained. Since a user is in a position to visualize the visible image, decreasing the luminance of the pixels of the infrared image corresponding to the obtained address selectively obtains an image of an invisible object only, thereby improving the visibility of the target object, that is, an indistinct visible object.”

### RELATED ART DOCUMENTS

### Patent Documents

Patent Document 1: Japanese Patent Application Laid-Open No. 2003-189297

### SUMMARY OF THE INVENTION

### Problems to be Solved by the Invention

Patent Document 1 discloses that “since a user is in a position to visualize the visible image, decreasing the luminance of the pixels of the infrared image corresponding to the obtained address selectively obtains an image of an invisible object only, thereby improving the visibility of the target object, that is, an indistinct visible object”, but there is room for improvement because the indistinct visible object and the distinct visible object can be seen at the same time.

The present invention provides an imaging device and an imaging system having higher visibility.

### Means for Solving the Problems

The following is a brief description of an outline of the typical invention disclosed in the present application.

(1) An imaging device includes an imaging unit that acquires a visible light signal and an invisible light signal by imaging a subject, a first luminance generation unit that generates a visible light luminance signal by using the visible light signal output from the imaging unit, a second luminance generation unit that generates an invisible light luminance signal by using the invisible light signal output from the imaging unit, an image correction processing unit that performs a correction process by using the visible light luminance signal generated by the first luminance generation unit and the invisible light luminance signal generated by the second luminance generation unit and a control unit that controls at least the image correction processing unit; and the image correction processing unit performs the correction process by adding a correction signal, which is generated using the invisible light luminance signal, to the visible light signal.

(2) An imaging system includes an imaging device including an imaging unit that acquires a visible light signal and an invisible light signal by imaging a subject, a first luminance generation unit that generates a visible light luminance signal by using the visible light signal output from the imaging unit, a second luminance generation unit that generates an invisible light luminance signal by using the invisible light signal output from the imaging unit, and an image correction processing unit that performs a correction process by adding a correction signal, which is generated using the invisible light luminance signal generated by the second luminance generation unit, to the visible light luminance signal, which is generated by the first luminance generation unit, and a control unit that controls at least the image correction processing unit; and an image display means that receives a correction image, which is output from the imaging device, after the correction process as input, and displays the correction image.

### Effects of the Invention

According to the present invention, it is possible to provide an imaging device and an imaging system having higher visibility.

### BRIEF DESCRIPTIONS OF THE DRAWINGS

FIG. 1 is a diagram illustrating an embodiment of an imaging device according to the present invention.

FIG. 2 is a diagram illustrating an example of a pixel configuration of an imaging element used for an imaging unit of the imaging device illustrated in FIG. 1.

FIG. 3 is a diagram illustrating an example of spectral characteristics of pixels with respect to a wavelength of light in the imaging element illustrated in FIG. 2.

FIG. 4 is a diagram illustrating another example of spectral characteristics of pixels with respect to a wavelength of light in the imaging element illustrated in FIG. 2.

FIG. 5 is a diagram illustrating an example of a pixel configuration of a visible light+invisible light sensor that is different from the imaging element illustrated in FIG. 2.

FIG. 6 is a diagram illustrating an example of spectral characteristics of pixels with respect to a wavelength of light in the imaging element illustrated in FIG. 5.

FIG. 7 is a diagram illustrating another example of spectral characteristics of pixels with respect to a wavelength of light in the imaging element illustrated in FIG. 5.

FIG. 8 is a diagram illustrating an example of a specific configuration of an image correction processing unit of the imaging device illustrated in FIG. 1.

FIG. 9 is a diagram illustrating a modification example of the image correction processing unit of the imaging device illustrated in FIG. 1.

FIG. 10 is a diagram illustrating another example of a specific configuration of an imaging unit of the imaging device illustrated in FIG. 1.

FIG. 11 is a diagram illustrating an example of a lighting control of a separation light source of the imaging unit illustrated in FIG. 10.

FIG. 12 is a diagram illustrating another example of the lighting control of the separation light source of the imaging unit illustrated in FIG. 10.

FIG. 13 is a diagram illustrating an embodiment of an imaging system according to the present invention.

### DETAILED DESCRIPTION OF PREFERRED EMBODIMENTS

Hereinafter, embodiments of the present invention will be described below with reference to the drawings.

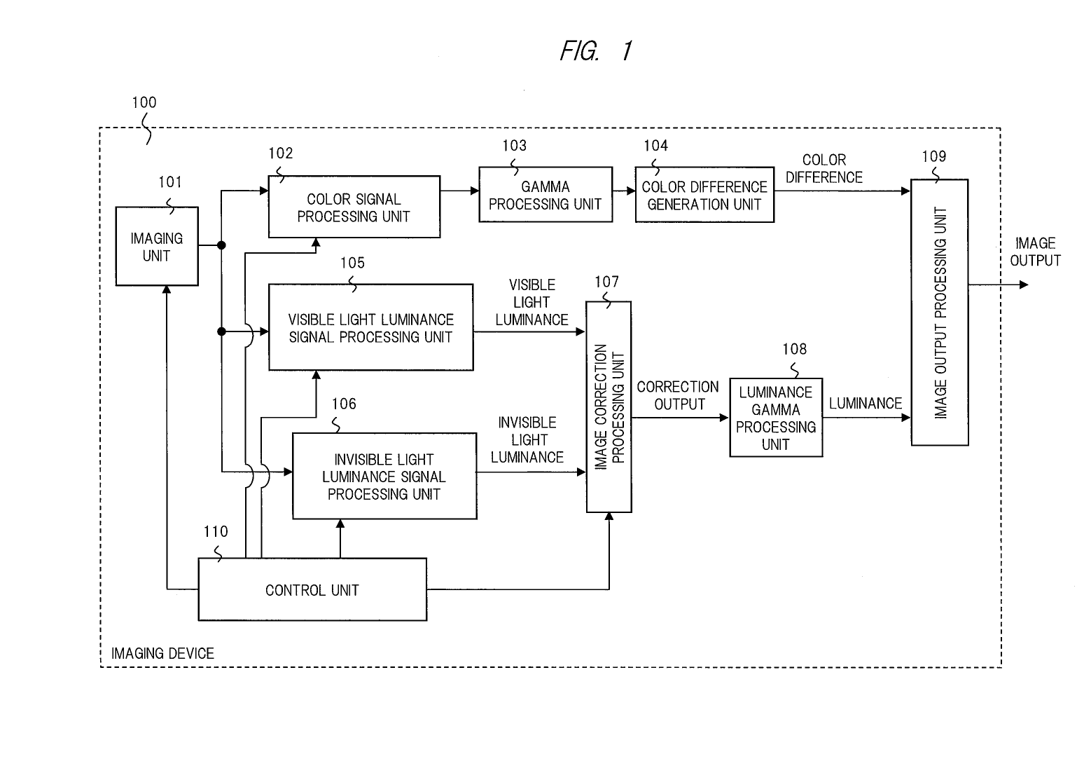

FIG. 1 is an entire configuration diagram illustrating an embodiment of an imaging device according to the present invention. Here, in the following, visible light is referred to as light having a wavelength band of all or any of green (hereinafter G) light, blue (hereinafter B) light, and red (hereinafter R) light, and invisible light is referred to as light having a wavelength band of infrared or near infrared (hereinafter IR) light.

The imaging device 100 of FIG. 1 is configured by appropriately using an imaging unit 101, a color signal processing unit 102, a gamma processing unit 103, a color difference generation unit 104, a visible light luminance signal processing unit 105 being a first luminance generation unit, an invisible light luminance signal processing unit 106 being a second luminance generation unit, an image correction processing unit 107, a luminance gamma processing unit 108, an image output processing unit 109, and a control unit 110.

The imaging unit 101 is configured by appropriately using an imaging element, which includes a pixel having sensitivity to light of a wavelength of a visible light region and a pixel having sensitivity to light of a wavelength of an invisible light region, as described below, and an optical system component such as a lens. The color signal processing unit 102 generates a color signal from the output of the imaging unit 101. The gamma processing unit 103 converts the color signal output from the color signal processing unit 102 into a gamma characteristic curve. The color difference generation unit 104 converts the output of the gamma processing unit 103 into a color difference signal.

The visible light luminance signal processing unit 105 generates a visible light luminance signal from a visible light component signal output of the imaging unit 101 by demosaicing or other processes. The invisible light luminance signal processing unit 106 generates an invisible light luminance signal from an invisible light signal output of the imaging unit 101 by demosaicing or other processes.

The image correction processing unit 107 combines the visible light luminance output of the visible light luminance signal processing unit 105 and the invisible light luminance output of the invisible light luminance signal processing unit 106 by a combining method described below. The luminance gamma processing unit 108 generates a luminance signal by converting a correction signal output of the image correction processing unit 107 into a gamma characteristic curve.

The image output processing unit 109 outputs the color difference signal output from the color difference generation unit 104 and the luminance signal output from the luminance gamma processing unit 108 according to a predetermined output specification (for example, the contents are not selected, like uncompressed digital output or compressed network output). The control unit 110 controls the imaging unit 101, the color signal processing unit 102, the visible light luminance signal processing unit 105, the invisible light luminance signal processing unit 106, or the image correction processing unit 107.

A visible light signal, which is photoelectrically converted in the imaging unit 101, experiences a color signal generation process in the color signal processing unit 102, a gamma correction process in the gamma processing unit 103, and a process of conversion into a color signal in the color difference generation unit 104, and is converted into a visible light luminance signal in the visible light luminance signal processing unit 105. An invisible light signal, which is photoelectrically converted in the imaging unit 101, is converted into an invisible light luminance signal in the invisible light luminance signal processing unit 106.

The visible light luminance signal and the invisible light luminance signal, which are obtained by these processes, experience an image correction process by the following combination process in the image correction processing unit 107 according to the control of the control unit 110 described below. The correction output of the image correction processing unit 107 is converted into a luminance signal having experienced the gamma correction process in the luminance gamma processing unit 108. The color difference signal generated by the color difference generation unit 104 and the luminance signal generated by the luminance gamma processing unit 108 are output as an image signal from the image output processing unit 109 to an external display device.

According to the present embodiment, the visible light component signal output from the imaging unit 101 is processed into the visible light luminance signal in the visible light luminance signal processing unit 105, the invisible light component signal output from the imaging unit 101 is processed into the invisible light luminance signal in the invisible light luminance signal processing unit 106, and the correction process is performed in the image correction processing unit 107 by using the two signals, without being limited to, in particular, the position of the image. Therefore, the present invention provides the imaging device in which both of a subject portion with high visibility in visible light on a screen and a subject portion with low visibility of poor visible light have high visibility as an entire screen.

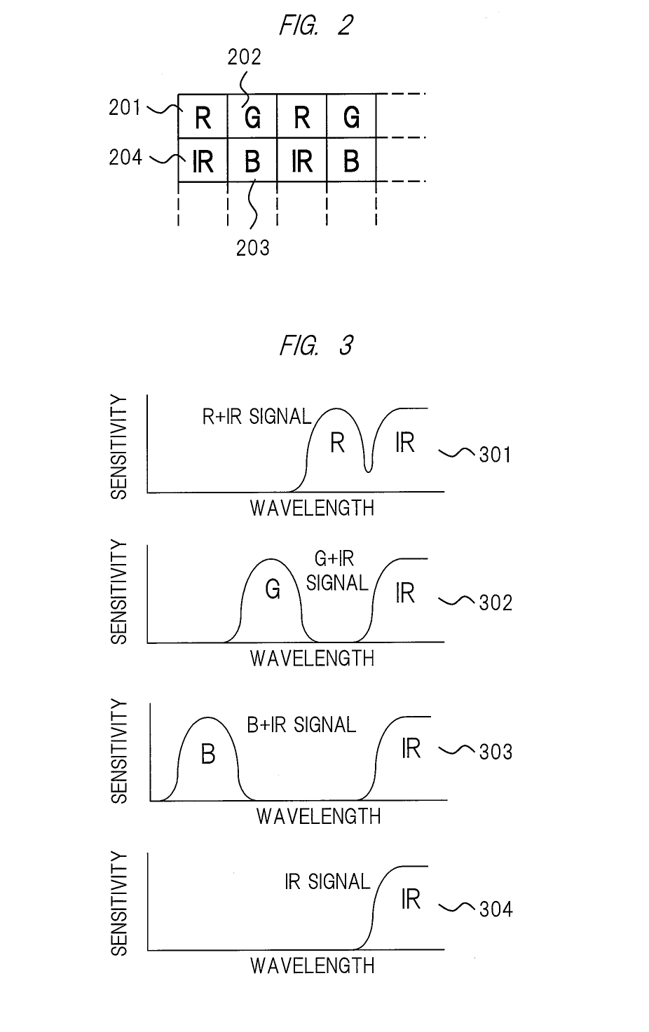

FIG. 2 is a diagram illustrating an example of a pixel configuration of an imaging element used for the imaging unit of the imaging device illustrated in FIG. 1. FIG. 2 illustrates an example in which a pixel 201 having main sensitivity to R, a pixel 202 having main sensitivity to G, a pixel 203 having main sensitivity to B, and a pixel 204 having main sensitivity to invisible light (denoted as IR) are arranged on the same imaging element in grid patterns. Pixels are configured by repeating the arrangement of the pixels 201 to the pixel 204 on the imaging element.

FIG. 3 is a diagram illustrating an example of sensitivity characteristics, i.e., spectral characteristics of pixels with respect to a wavelength of light in the imaging element illustrated in FIG. 2. In FIG. 3, reference numeral 301 is spectral characteristic of the pixel 201, reference numeral 302 is spectral characteristic of the pixel 202, reference numeral 303 is spectral characteristic of the pixel 203, and reference numeral 304 is spectral characteristic of the pixel 204.

The spectral characteristics 301, 302, and 303 have sensitivity in a wavelength region of IR in addition to wavelength regions being visible light of R, G, and B, respectively. A camera of a normal visible light region only is configured by pixels having these spectral characteristics. Generally, in order to image the visible light region only, an optical filter that blocks a wavelength region of IR is inserted on an optical axis of a lens and an imaging element so as to eliminate the influence of the IR component. The spectral characteristic 304 has sensitivity in IR only. By providing this pixel in conjunction with the pixels having sensitivity of the visible light region, the color components and luminance components of the visible light region (R, G, B) and the luminance component by the IR can be imaged at the same time.

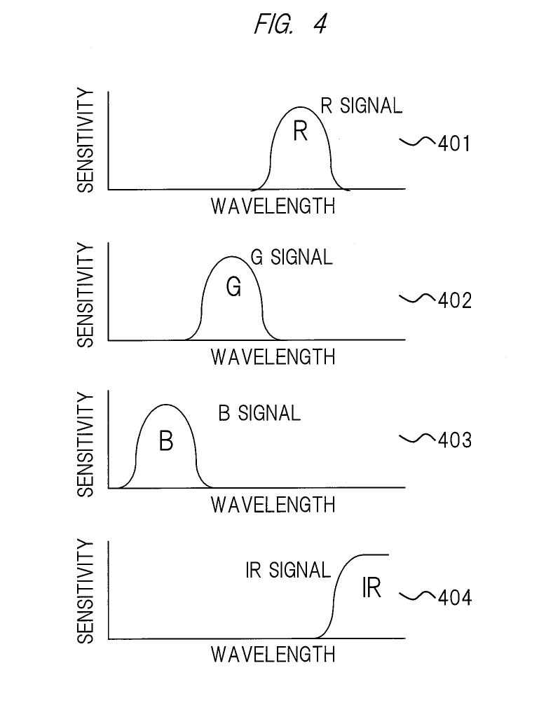

FIG. 4 is a diagram illustrating another example of spectral characteristics of pixels with respect to a wavelength of light in the imaging element illustrated in FIG. 2. In FIG. 4, reference numeral 401 is another spectral characteristic of the pixel 201, reference numeral 402 is another spectral characteristic of the pixel 202, reference numeral 403 is another spectral characteristic of the pixel 203, and reference numeral 404 is spectral characteristic of the pixel 204. The spectral characteristics 401, 402, and 403 have sensitivity only in wavelength regions being visible light of R, G, and B, respectively. The spectral characteristic 404 has sensitivity in IR only. By providing this pixel in conjunction with the pixels having sensitivity of the visible light region, the color components and luminance components of the visible light region (R, G, B) and the luminance component by the IR can be imaged at the same time.

Generally, in order to image the visible light region only, an optical filter that blocks a wavelength region of IR is inserted on an optical axis of a lens and an imaging element so as to eliminate the influence of the IR component, and it is necessary to perform visible light signal processing. However, according to the present embodiment, since R, G, and B do not originally include the IR component, the same visible light signal processing as the past can be used by a simple configuration, without using the filter. Therefore, it is possible to provide the imaging device advantageous in terms of color reproduction or the like, without changing the conventional signal processing.

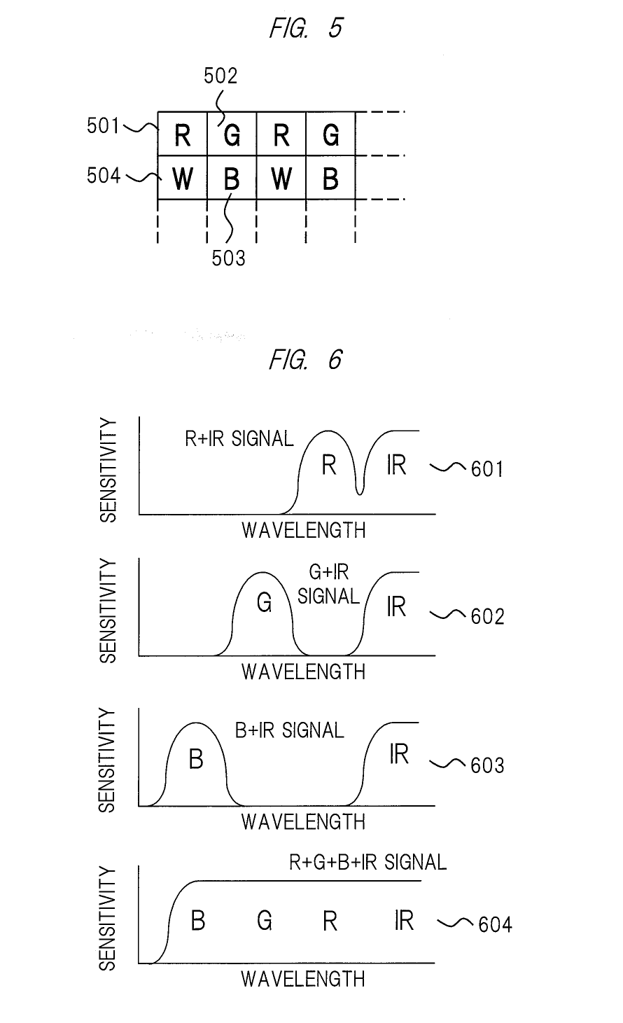

FIG. 5 is a diagram illustrating an example of a pixel configuration of a visible light+invisible light sensor that is different from the imaging element illustrated in FIG. 2. FIG. 5 illustrates an example in which a pixel 501 having main sensitivity to R, a pixel 502 having main sensitivity to G, a pixel 503 having main sensitivity to B, and a pixel 504 (dented as W) having sensitivity to all of R, G, B, and IR are arranged on the same imaging element in grid patterns. Pixels are configured by repeating the arrangement of the pixels 501 to the pixel 504 on the imaging element.

FIG. 6 is a diagram illustrating an example of sensitivity characteristics, i.e., spectral characteristics of pixels with respect to a wavelength of light in the imaging element illustrated in FIG. 5. In FIG. 6, reference numeral 601 is spectral characteristic of the pixel 501, reference numeral 602 is spectral characteristic of the pixel 502, reference numeral 603 is spectral characteristic of the pixel 503, and reference numeral 604 is spectral characteristic of the pixel 504. The spectral characteristics 601, 602, and 603 have a wavelength region of IR in addition to wavelength regions being visible light of R, G, and B.

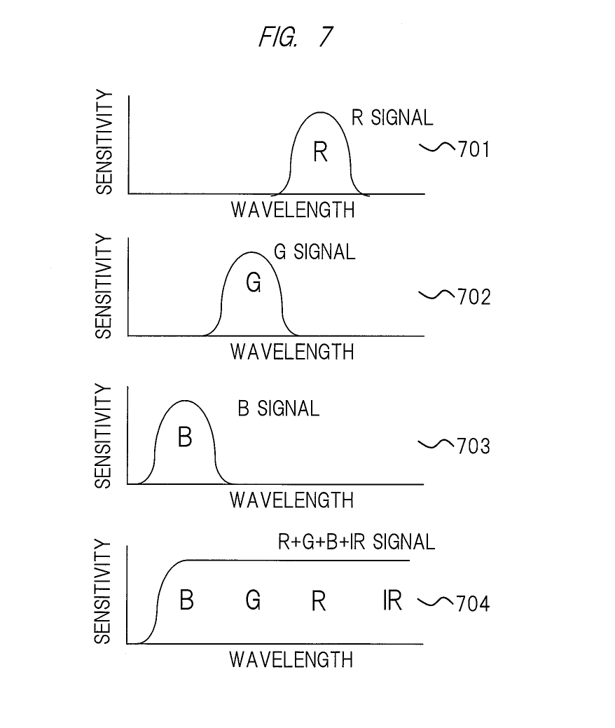

FIG. 7 is a diagram illustrating another example of spectral characteristics of pixels with respect to a wavelength of light in the imaging element illustrated in FIG. 5. In FIG. 7, reference numeral 701 is another spectral characteristic of the pixel 501, reference numeral 702 is another spectral characteristic of the pixel 502, reference numeral 703 is another spectral characteristic of the pixel 503, and reference numeral 704 is spectral characteristic of the pixel 504. The spectral characteristics 701, 702, and 703 have sensitivity only in wavelength regions being visible light of R, G, and B, respectively. The spectral characteristic 704 has sensitivity in all of R, G, B, and IR. By providing this pixel in conjunction with the pixels having sensitivity of the visible light region, the color components and luminance components of the visible light region (R, G, B) and the luminance component by the IR can be imaged at the same time.

In the imaging element having the present pixel configuration, in addition to the pixels having each sensitivity of R, G, and B of the pixels 501 to the pixel 503, the pixel 504 also has the sensitivity to R, G, and B of the visible light region. Therefore, it is possible to provide the imaging device that has higher sensitivity to the visible light region.

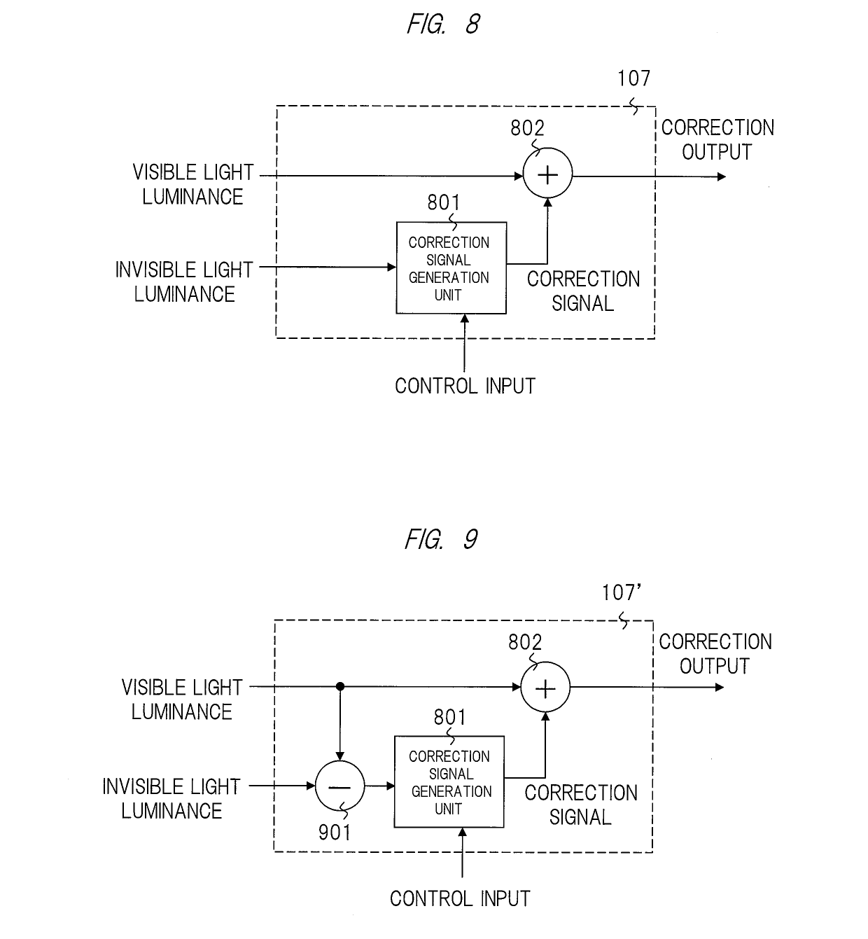

FIG. 8 is a diagram illustrating an example of a specific configuration of the image correction processing unit of the imaging device illustrated in FIG. 1. The image correction processing unit 107, as appropriate, includes a correction signal generation unit 801 that generates an amount of a correction signal according to a level of the invisible light luminance signal generated in the invisible light luminance signal processing unit 106 by a setting of the control unit 110, and an addition unit 802 that adds the correction signal generated by the correction signal generation unit 801 to the visible light luminance signal generated by the visible light luminance signal processing unit 105. For example, the correction signal generation unit 801 is configured such that input/output characteristics of taking the level of the invisible light luminance signal as input, and taking the amount of the correction signal corresponding thereto as output are set by the control unit 110.

According to the present configuration, it is possible to provide the imaging device that can perform the image correction according to the level of the invisible light luminance signal, because of the invisible light signal to be added to the visible light signal according to the level of the invisible light luminance signal, by adding a part of the invisible light signal to the visible light signal according to the level of the invisible light luminance signal, that can generate a luminance signal having better visibility than the imaging device having the sensitivity of the visible light only, and that can optionally change the amount of the correction signal according to the level of the invisible light luminance signal, which is set from the control unit 110, by changing the input/output characteristics from the control unit 110.

FIG. 9 is a diagram illustrating a modification example of the image correction processing unit of the imaging device illustrated in FIG. 1 and is a diagram illustrating a specific configuration of an image correction processing unit 107′ as the modification example of the image correction processing unit 107. The image correction processing unit 107′ includes a difference circuit 901 that generates a difference between the visible light luminance signal generated by the visible light luminance signal processing unit 105 and the invisible light luminance signal generated by the invisible light luminance signal processing unit 106, and as appropriate, includes a correction signal generation unit 801 and an addition unit 802, each of which has the same configuration as that illustrated in FIG. 8, except that the input to the correction signal generation unit 801 is the difference circuit 901.

According to the present configuration, it is possible to provide the imaging device that can perform the image correction according to the level difference between the invisible light luminance signal and the visible light luminance signal by adding a part of the invisible light signal to the visible light signal according to the difference between the level of the invisible light luminance signal and the level of the visible light luminance signal, that can generate a luminance signal having better visibility than the imaging device having the sensitivity of the visible light only, and that can optionally change the amount of the correction signal according to the level difference between the invisible light luminance signal and the visible light luminance signal, which is set by the control unit 110, by changing the input/output characteristics from the control unit 110.

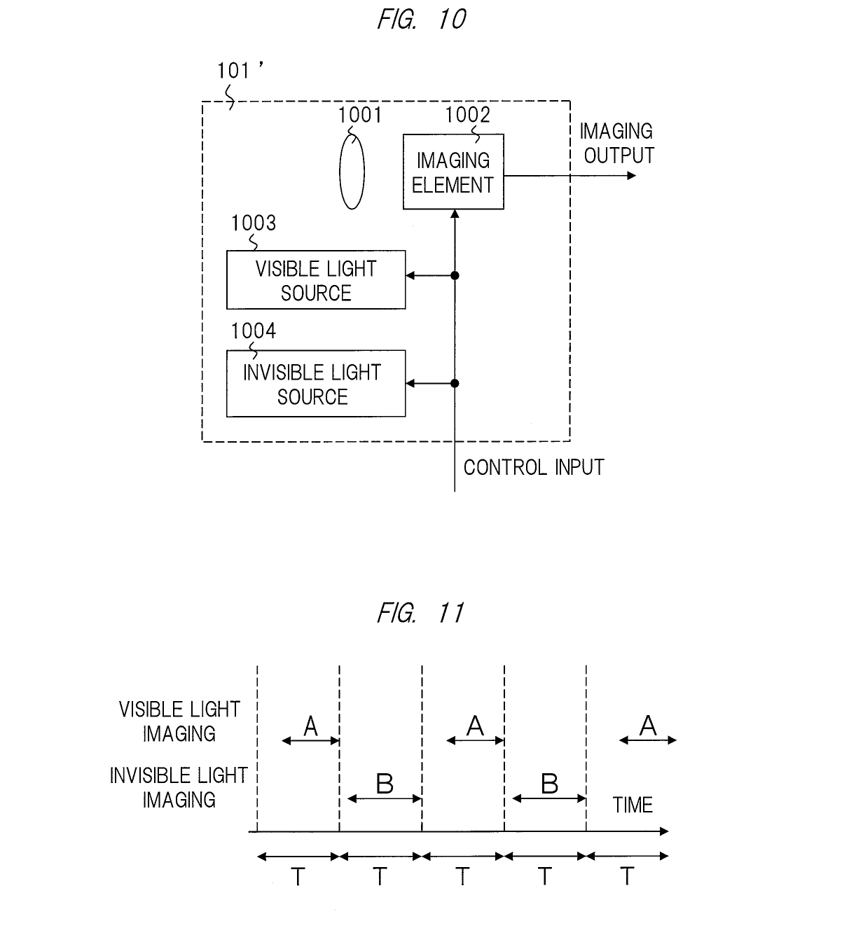

FIG. 10 is a diagram illustrating another example of the specific configuration of the imaging unit of the imaging device illustrated in FIG. 1 and is a diagram illustrating a specific configuration of the imaging unit 101′ as a modification example of the imaging unit 101 illustrated in FIG. 1.

The imaging unit 101 is configured by appropriately using a lens 1001, an imaging element 1002, a visible light source 1003, and an invisible light source 1004. The visible light source 1003 and the invisible light source 1004 may be a light source that can emit visible light and invisible light by one of them (this is referred to as a single light source), or may be separated as illustrated in FIG. 10 (this is referred to as a separation light source). The lighting time or timing of the visible light source 1003 and the invisible light source 1004 can be controlled by the control unit 110.

According to such a configuration, in a laparoscope or the like used for medical treatment, a light source can be optionally selected according to a desired imaging target, like a visceral surface reflecting the visible light and a blood vessel or a lymph node easily reflecting the invisible light due to administration of a contrast agent. Therefore, it is possible to provide the imaging device that allows a user to see an emphasized image of a lymphatic vessel that can be imaged by the invisible light as well as the visceral surface that can be imaged by the visible light, through a single device.

FIG. 11 is a diagram illustrating an example of a lighting control of the separation light source of the imaging unit illustrated in FIG. 10, and illustrates an example of a lighting control that switches in synchronization with exposure time every time T by turning on the visible light source 1003 at time A and the invisible light source 1004 at time B by the control unit 110. According to such a configuration, it is possible to optimally control the amount of the visible light and the invisible light.

It is also possible to eliminate the influence of the two light sources at the time of imaging, and thereby to acquire an optimal combined image of the visible light luminance and the invisible light luminance. The switching time T is not necessarily constant and, the time of the visible light imaging and the time of the invisible light imaging may be changed depending on the situation.

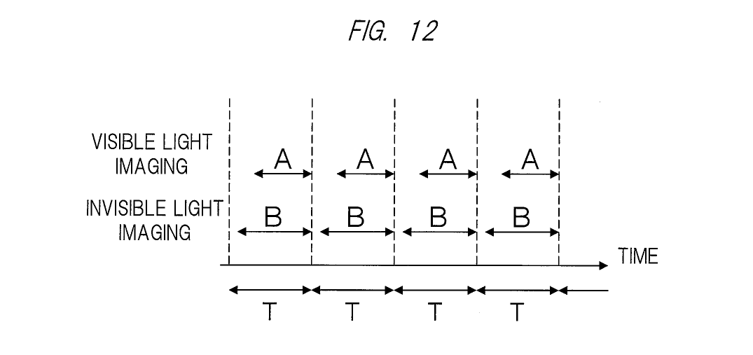

FIG. 12 is a diagram illustrating another example of a lighting control of the separation light source of the imaging unit illustrated in FIG. 10, and illustrates an example of a lighting control that simultaneously turns on the visible light source 1003 at time A and the invisible light source 1004 at time B every time T by the control unit 110. Such a lighting control can optimally control the amount of the visible light and the invisible light, and quicken an acquisition frame rate of an optimal combined image of the visible light luminance and the invisible light luminance as compared with the case of FIG. 11.

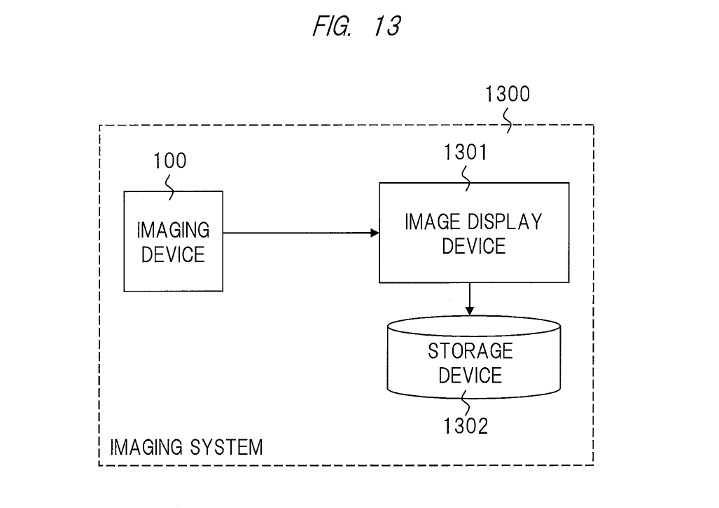

FIG. 13 is a diagram illustrating an embodiment of an imaging system according to the present invention, and illustrates an imaging system 1300 that is configured by appropriately using the imaging device 100 illustrated in FIG. 1, an image display device 1301 that displays a correction image output from the imaging device 100, and a storage device 1302 that records the correction image output from the imaging device 100.

The image display device 1301 is not limited as long as the image display device 1301 has an image display function, like a personal computer or a monitor TV having an interface that can be connected to the imaging device 100. In addition, the transmission of the image signal from the imaging device 100 to the image display device 1301 may be performed by wire or wireless. The storage device 1302 is, for example, a hard disk or a portable storage medium embedded in a personal computer, but can be variously applied without being limited thereto.

When configured as above, the combined image of both the visible light and the invisible light of the laparoscope in medical treatment or the like can be displayed and grasped in real time. Furthermore, when the present imaging system is configured using the storage device 1302, an image intended to be recorded can be stored in the storage unit. The storage device 1302 is a hard disk or a portable storage medium embedded in a personal computer, but is not limited thereto.

According to the present imaging system, it is possible to obtain the above-described effects of the imaging device according to the present embodiment, and acquire and confirm an image having higher visibility than before. In the present embodiment, the imaging device 100 is configured to include all the processing units, but the imaging system may be configured in the form providing the configuration that each processing function unit is provided, for example, on the image display device side. Such a form can be variously changed according to applications such as an onboard camera system or a medical camera system.

As described above, according to the imaging device and the imaging system of the present embodiment, it is possible to provide an imaging device and an imaging system in which both of a subject portion with high visibility in visible light on a screen and a subject portion with low visibility of poor visible light have high visibility as an entire screen.

The present invention is not limited to the foregoing embodiments and but includes various modification examples. For example, the above-described embodiment concretely described the present invention so that the present invention can be easily understood, and thus the present invention is not necessarily limited to the one including all the configurations described in the foregoing. Further, part of the configuration of a certain embodiment can be replaced by the configuration of another embodiment, and the configuration of the other embodiment can be added to the configuration of the certain embodiment. Moreover, part of the configuration of the embodiment can be subjected to addition/deletion/replacement of other configurations.

Further, as for each of the above-described configurations, a part or the whole thereof may be implemented by hardware, or may be implemented by executing a program in a processor. Furthermore, with respect to the control line and information line, those supposed to be necessary for explanation are shown, and all of the control lines and information lines in the product are not necessarily shown.

It is right thinking that almost all configurations are connected to each other in actual fact.

### REFERENCE SIGNS LIST

100 imaging device
101 imaging unit
102 color signal processing unit
103 gamma processing unit
104 color difference generation unit
105 visible light luminance signal processing unit
106 invisible light luminance signal processing unit
107 image correction processing unit
108 luminance gamma processing unit
109 image output processing unit
110 control unit

1. An imaging device comprising:
an imaging unit that acquires a visible light signal and an invisible light signal by imaging a subject;
a first luminance generation unit that generates a visible light luminance signal by using the visible light signal output from the imaging unit;
a second luminance generation unit that generates an invisible light luminance signal by using the invisible light signal output from the imaging unit;
an image correction processing unit that performs a correction process by using the visible light luminance signal generated by the first luminance generation unit and the invisible light luminance signal generated by the second luminance generation unit; and
a control unit that controls at least the image correction processing unit,
wherein the image correction processing unit performs the correction process by adding a correction signal, which is generated using the invisible light luminance signal, to the visible light signal.

2. The imaging device according to claim 1,
wherein the correction signal is generated according to a level of the invisible light luminance signal by using input/output characteristics set by the control unit.

3. The imaging device according to claim 1,
wherein the correction signal is generated according to a level of a difference between the invisible light luminance signal and the visible light luminance signal by using input/output characteristics set by the control unit.

4. The imaging device according to claim 1,
wherein the imaging unit further includes a light source of visible light and invisible light, and
the control unit performs a lighting control to the light source in synchronization with exposure time.

5. The imaging device according to claim 1,
wherein the imaging unit further includes a light source of visible light and invisible light, and
the control unit performs control such that the visible light and the invisible light of the light source are switched and turned on in synchronization with exposure time.

6. The imaging device according to claim 1,
wherein an imaging element included in the imaging unit includes a pixel having main sensitivity to red light, a pixel having main sensitivity to blue light, a pixel having main sensitivity to green light, and a pixel having main sensitivity to invisible light.

7. The imaging device according to claim 1,
wherein an imaging element included in the imaging unit includes a pixel having main sensitivity to red light, a pixel having main sensitivity to blue light, a pixel having main sensitivity to green light, and a pixel having sensitivity to red light, blue light, green light, and invisible light.

8. An imaging system comprising:
an imaging device including:
an imaging unit that acquires a visible light signal and an invisible light signal by imaging a subject;
a first luminance generation unit that generates a visible light luminance signal by using the visible light signal output from the imaging unit;
a second luminance generation unit that generates an invisible light luminance signal by using the invisible light signal output from the imaging unit; and
an image correction processing unit that performs a correction process by adding a correction signal, which is generated using the invisible light luminance signal generated by the second luminance generation unit, to the visible light luminance signal, which is generated by the first luminance generation unit; and
a control unit that controls at least the image correction processing unit; and
an image display means that receives a correction image, which is output from the imaging device, after the correction process as input, and displays the correction image.

9. The imaging system according to claim 8,
wherein the correction signal is generated according to a level of the invisible light luminance signal by using input/output characteristics set by the control unit.

10. The imaging system according to claim 8,
wherein the correction signal is generated according to a level of a difference between the invisible light luminance signal and the visible light luminance signal by using input/output characteristics set by the control unit.

11. The imaging system according to claim 8, further comprising a recording device capable of recording the correction image.
